(19) United States
(12) Patent Application Publication
(10) Pub. No.: US 2024/0220073 A1
(43) Pub. Date: Jul. 4, 2024

(54) METHOD AND APPARATUS FOR GUIDING OPERATING BODY FOR AIR OPERATION

(71) Applicant: Shenzhen Horizon Robotics Technology Co., Ltd., Shenzhen, Guangdong (CN)

(72) Inventors: Jizhou LONG, Shenzhen, Guangdong (CN); Feilong MO, Shenzhen, Guangdong (CN); Shaopeng LI, Shenzhen, Guangdong (CN); Liang XU, Shenzhen, Guangdong (CN); Junkai SUN, Shenzhen, Guangdong (CN)

(21) Appl. No.: 17/998,997

(22) PCT Filed: Jan. 29, 2022
(86) PCT No.: PCT/CN2022/075031

§ 371 Date: Dec. 22, 2022

(30) Foreign Application Priority Data
Jun. 15, 2021 (CN) 202110661817.3

(51) Int. Cl. G06F 3/0482; G06F 3/04817; G06F 3/16

(52) U.S. Cl. CPC G06F 3/0482; G06F 3/04817; G06F 3/167

(57) ABSTRACT

The embodiments of the present disclosure disclose a method and apparatus for guiding an operating body for air operation, a computer-readable storage medium, and an electronic device. The method includes: displaying, on a screen, a graphic menu having a first preset shape and an icon in mapping with an operating body and having a second preset shape; detecting an air operation of the operating body with respect to the screen in a space; detecting a movement physical quantity of the icon on the screen in response to the air operation; and triggering, based on the movement physical quantity and a target function region in the graphic menu corresponding to the icon, a menu function corresponding to the target function region. According to the embodiments of the present disclosure, a user may be guided visually to perform air operations with the operating body, and thus knows clearly how to trigger various functions with the operating body, which helps the user to perform air operations accurately. In addition, the number of functions triggered by air operations may be increased under the assistance of the graphic menu, thereby further making it more convenient for the user to perform air operations.

### FIELD OF THE PRESENT DISCLOSURE

The present disclosure relates to the technical field of computers, and particularly to a method and apparatus for guiding an operating body for air operation, a computer-readable storage medium, and an electronic device.

### BACKGROUND OF THE PRESENT DISCLOSURE

With the development of an artificial intelligence technology, air operation for pictures displayed on screens has been applied to more and more fields. Air operation may be applied to Augmented Reality (AR)/Virtual Reality (VR), smart phones, an intelligent household appliance, and other scenarios. When it is inconvenient for a user to operate a control panel with his/her hand directly, a machine is controlled by air operation, so that convenience is brought to the user.

According to an existing gesture-recognition-based air operation solution, gesture recognition is usually performed on a hand image shot by a camera, and a corresponding operation is performed according to a type, moving trajectory, etc., of a gesture.

### SUMMARY OF THE PRESENT DISCLOSURE

Embodiments of the present disclosure provide a method and apparatus for guiding an operating body for air operation, a computer-readable storage medium, and an electronic device.

The embodiments of the present disclosure provide a method for guiding an operating body for air operation, including: displaying, on a screen, a graphic menu having a first preset shape and an icon in mapping with an operating body and having a second preset shape; detecting an air operation of the operating body with respect to the screen in a space; detecting a movement physical quantity of the icon on the screen in response to the air operation; and triggering, based on the movement physical quantity and a target function region in the graphic menu corresponding to the icon, a menu function corresponding to the target function region.

According to another aspect of the embodiments of the present disclosure, an apparatus for guiding an operating body for air operation is provided, including a display module, a first detection module, a second detection module, and a triggering module. The display module is configured to display, on a screen, a graphic menu having a first preset shape and an icon in mapping with an operating body and having a second preset shape. The first detection module is configured to detect an air operation of the operating body with respect to the screen in a space. The second detection module is configured to detect a movement physical quantity of the icon on the screen in response to the air operation. The triggering module is configured to trigger, based on the movement physical quantity and a target function region in the graphic menu corresponding to the icon, a menu function corresponding to the target function region.

According to another aspect of the embodiments of the present disclosure, a computer-readable storage medium is provided, storing a computer program which is used for executing the method for guiding an operating body for air operation.

According to another aspect of the embodiments of the present disclosure, an electronic device is provided, including: a processor; and a memory configured to store instructions executable for the processor. The processor is configured to read the executable instructions from the memory and execute the instructions to implement the method for guiding an operating body for air operation.

Based on the method and apparatus for guiding an operating body for air operation, computer-readable storage medium, and electronic device provided in the above-mentioned embodiments of the present disclosure, the graphic menu and the icon in mapping with the operating body are displayed on the screen, then the air operation of the operating body with respect to the screen in the space is detected, meanwhile, the movement physical quantity of the icon on the screen is detected, and finally, the menu function corresponding to the target function region is triggered based on the movement physical quantity and the target function region in the graphic menu corresponding to the icon. As such, when a user performs air operations, the user may be guided visually by the graphic menu and icon displayed on the screen to perform the air operations with the operating body, and thus knows clearly how to trigger various functions with the operating body, which helps the user to perform air operations accurately. In addition, the number of menu items displayed on the graphic menu may be adjusted to further increase the number of menu functions triggered by air operations, so that the user may perform air operations more conveniently.

The technical solutions of the present disclosure will further be described below through the drawings and the embodiments in detail.

### BRIEF DESCRIPTION OF THE DRAWINGS

The above and other objectives, features, and advantages of the present disclosure will be more apparent upon describing the embodiments of the present disclosure in more detail with reference to the drawings. The drawings, which constitute a part of the specification, are used to provide further understandings of the embodiments of the present disclosure and explain, together with the embodiments of the present disclosure, the present disclosure and not intended to form limitations on the present disclosure. In the drawings, the same reference signs usually represent the same components or steps.

FIG. 1A is a diagram of a system to which the present disclosure is applied.

FIG. 1B is a schematic diagram of a screen of a system architecture to which the present disclosure is applied.

FIG. 2 is a schematic flowchart of a method for guiding an operating body for air operation according to an exemplary embodiment of the present disclosure.

FIG. 3 is a schematic flowchart of a method for guiding an operating body for air operation according to another exemplary embodiment of the present disclosure.

FIG. 4 is a schematic flowchart of a method for guiding an operating body for air operation according to another exemplary embodiment of the present disclosure.

FIG. 5 is a schematic flowchart of a method for guiding an operating body for air operation according to another exemplary embodiment of the present disclosure.

FIGS. 6A, 6B, and 6C are exemplary schematic diagrams of triggering a target function region in a method for guiding an operating body for air operation according to another exemplary embodiment of the present disclosure.

FIG. 7 is a schematic flowchart of a method for guiding an operating body for air operation according to another exemplary embodiment of the present disclosure.

FIG. 8 is an exemplary schematic diagram of an adjustment control interface for continuous adjustment in a method for guiding an operating body for air operation according to another exemplary embodiment of the present disclosure.

FIG. 9 is a schematic structural diagram of an apparatus for guiding an operating body for air operation according to an exemplary embodiment of the present disclosure.

FIG. 10 is a schematic structural diagram of an apparatus for guiding an operating body for air operation according to another exemplary embodiment of the present disclosure.

FIG. 11 is a structural diagram of an electronic device according to an exemplary embodiment of the present disclosure.

### DESCRIPTION OF THE EMBODIMENTS

Exemplary embodiments according to the present disclosure will now be described in detail with reference to the drawings. Clearly, the described embodiments are not all but only part of embodiments of the present disclosure. It is to be understood that the present disclosure is not limited to the exemplary embodiments described herein.

It is to be noted that the relative arrangement of components and steps, numeric expressions, and numeric values described in these embodiments do not limit the scope of the present disclosure, unless otherwise specifically described.

It can be understood by those skilled in the art that terms such as “first” and “second” in the embodiments of the present disclosure are only for distinguishing different steps, devices, or modules and do not represent any specific technical meanings as well as necessary logical sequences thereof.

It is also to be understood that, in the embodiments of the present disclosure, “multiple” may refer to two or more than two, and “at least one” may refer to one, two, or more than two.

It is also to be understood that, for any component, data, or structure mentioned in the embodiments of the present disclosure, the number thereof can be understood as one or multiple if there are no specific limits or opposite revelations are presented in the context.

In addition, term “and/or” in the present disclosure is only an association relationship describing associated objects and represents that three relationships may exist. For example, A and/or B may represent three conditions: i.e., existence of only A, existence of both A and B, and existence of only B. Moreover, character “/” in the present disclosure usually represents an “or” relationship between previous and next associated objects.

It is also to be understood that, in the present disclosure, the descriptions about each embodiment stress on differences between the embodiments, and the same or similar parts may refer to each other and will not be elaborated for simplicity.

In addition, it is to be understood that, for ease of description, the size of each part shown in the drawings is not drawn according to an actual proportional relationship.

The following descriptions about at least one exemplary embodiment are only illustrative in fact and do not form any limitation on the present disclosure as well as the application or use thereof.

Technologies, methods, and devices known to those of ordinary skill in the art may not be discussed in detail, but the technologies, the methods, and the devices should be considered as a part of the specification as appropriate.

It is to be noted that similar reference signs and letters represent similar items in the following drawings, and thus a certain item, once being defined in a drawing, needs not to be further discussed in subsequent drawings.

The embodiments of the present disclosure may be applied to an electronic device such as a terminal device, a computer system, and a server, which may be operated together with many other universal or dedicated computing systems, environments, or configurations. Examples of well-known terminal devices, computing systems, environments, and/or configurations suitable for use together with the electronic device such as the terminal device, the computer system, and the server include, but not limited to, a personal computer system, a server computer system, a thin client, a thick client, a handheld or laptop device, a microprocessor-based system, a set-top box, a programmable consumer electronic product, a network personal computer, a microcomputer system, a large computer system, a distributed cloud computing technical environment including any above-mentioned system, etc.

The electronic device such as the terminal device, the computer system, and the server may be described in a general context of computer system executable instructions (such as a program module) executed by a computer system. Generally speaking, the program module may include a routine, a program, a target program, a component, a logic, a data structure, etc., and they execute specific tasks or implement specific abstract data types. The computer system/server may be implemented in a distributed cloud computing environment. In the distributed cloud computing environment, tasks are executed by remote processing devices connected by a communication network, and program modules may be in a local or remote computer system storage medium including a memory device.

### SUMMARY OF THE APPLICATION

During man-machine interaction in an existing air operation method, no operation tips are displayed on a screen, and thus a user cannot be guided appropriately, namely the user does not know how to perform gesture operations as well as correspondences between different operation modes (such as gestures) and different functions, and only after a blind operation succeeds, may be prompted that the operation succeeds. In addition, the existing air operation method has great restrictions on a speed, amplitude, gesture, etc., of an operating body, and the user needs to operate with standard actions. Finally, in the existing air operation method, one action or posture corresponds to only one function, so that the extensibility of air operation is relatively low.

### Exemplary System

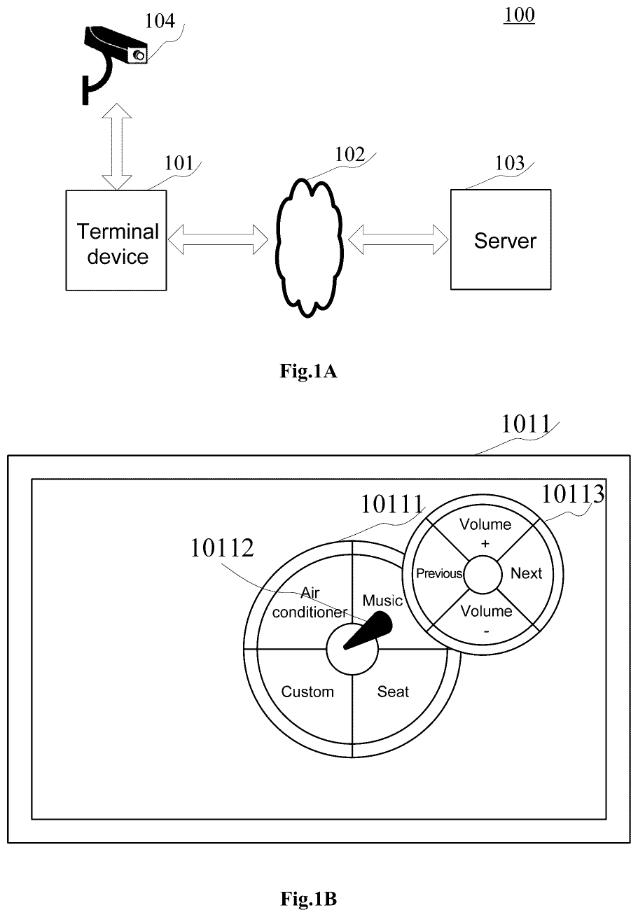

FIG. 1A shows an exemplary system architecture 100 to which a method for guiding an operating body for air operation or apparatus for guiding an operating body for air operation in the embodiments of the present disclosure may be applied. FIG. 1B is a schematic diagram of a screen 1011 on a terminal device 101.

As shown in FIG. 1A, the system architecture 100 may include a terminal device 101, a network 102, a server 103, and a data acquisition device 104. The network 102 is configured to provide a medium for a communication link between the terminal device 101 and the server 103. The network 102 may include various connection types, such as wired and wireless communication links or optical fiber cables.

A user may interact with the server 103 by use of the terminal device 101 through the network 102, so as to receive or send messages, etc. Various communication client applications may be installed in the terminal device 101, such as an audio and video playing application, a navigation application, a game application, a search application, a web browser application, or an instant messaging tool.

The terminal device 101 may be various electronic devices, including, but not limited to, a mobile terminal such as a vehicular terminal, a mobile phone, a notebook computer, a digital broadcast receiver, a Personal Digital Assistant (PDA), a Portable Android Device (PAD), and a Portable Media Player (PMP), and a fixed terminal such as a digital Television (TV) and a desktop computer. The terminal device 101 generally includes a screen 1011 shown in FIG. 1. A graphic menu and an icon corresponding to a real-time position of an operating body may be displayed on the screen 1011. The user performs man-machine interaction with the terminal device 101 or the server 103 through the screen 1011.

The server 103 may be a server providing various types of service, such as a background server analyzing a posture, position, etc., of the operating body uploaded by the terminal device 101 in real time. The background server may respond to an air operation of the user to obtain a processing result (such as a command instructing triggering of a menu function), and feed back the processing result to the terminal device.

The data acquisition device 104 may be various devices configured to acquire data about the position, posture, etc., of the operating body, such as a monocular camera, a binocular stereo camera, a laser radar, or a three-dimensional structured light imaging device.

It is to be noted that a method for guiding an operating body for air operation in the embodiments of the present disclosure may be executed by the server 103 or the terminal device 101, and correspondingly, an apparatus for guiding an operating body for air operation may be arranged in the server 103 or the terminal device 101.

It is to be understood that the numbers of the terminal device, network, and server in FIG. 1A are only schematic. The system architecture may include any number of terminal devices, networks, and servers as needed by implementation. The system architecture may include no network but only the server or the terminal device if the data needed by recognizing the operating body needs not to be acquired remotely.

### Exemplary Method

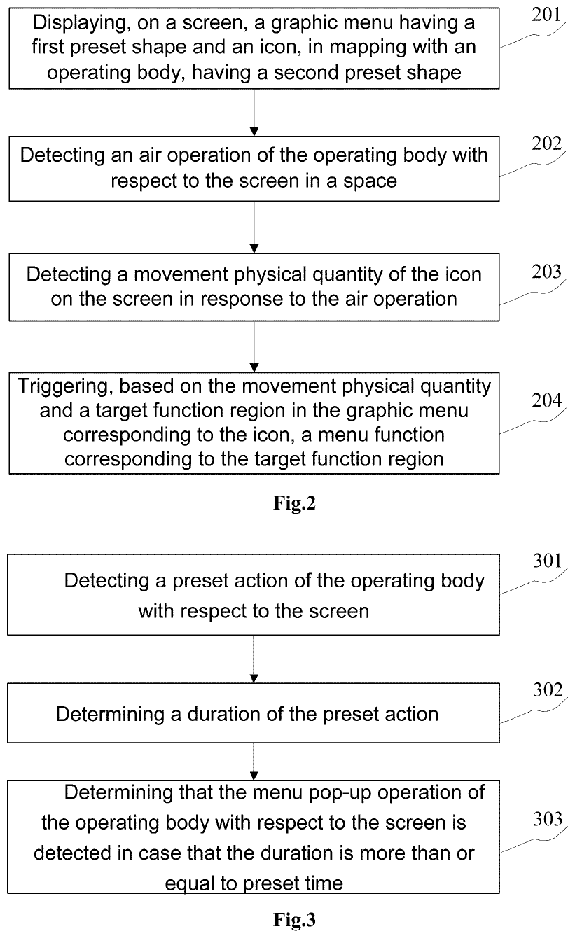

FIG. 2 is a schematic flowchart of a method for guiding an operating body for air operation according to an exemplary embodiment of the present disclosure. The present embodiment may be applied to an electronic device (such as a terminal device 101 or server shown in FIG. 1A). As shown in FIG. 2, the method includes the following steps.

In step 201, a graphic menu having a first preset shape and an icon, in mapping with an operating body, having a second preset shape are displayed on a screen.

In the present embodiment, the electronic device may display, on the screen 1011 shown in FIG. 1B, a graphic menu having a first preset shape and an icon in mapping with an operating body and having a second preset shape. The screen may be a screen of any type of electronic device, such as a central control panel in a vehicle, a smart TV placed indoors, and a smart phone.

The first preset shape of the graphic menu may be any shape. For example, the graphic menu may be a round menu 10111 shown in FIG. 1B, or a rectangular menu not shown in FIG. 1B. The graphic menu includes at least one function region. Each function region may be triggered to execute a corresponding menu function, such as popping up a sub-menu, performing volume adjustment, changing the music, and controlling a specific device to be turned on or off.

The operating body may be various hardware entities or a specific body part of a user performing air operations on a controlled device. For example, the operating body may be a body part of the user such as a hand or the head, or a hardware entity of a preset shape and capable of outputting position information to the electronic device such as a handle. For example, the preset shape may be a V shape. Alternatively, the operating body may be another object of a specific shape.

The electronic device may detect a position of the operating body in a space in real time, map the detected position to a corresponding position on the screen, and display an icon 10112 having a second preset shape shown in FIG. 1B at the corresponding position on the screen, thereby presenting an effect that a position of the icon moves with the operating body. The second preset shape may be various shapes, such as a tailing water drop shown in FIG. 1B, as well as a sphere, point, pointer, etc., not shown in FIG. 1B.

In such case, mapping between the icon and the operating body refers to that a position of the icon on the screen is the corresponding position that the position of the operating body in the space is mapped to on the screen. Correspondingly, the position of the icon on the screen moves with the operating body during the movement of the operating body.

In step 202, an air operation of the operating body with respect to the screen in a space is detected.

In the present embodiment, the electronic device may detect an air operation of the operating body with respect to the screen in a space in real time based on various methods. The air operation may be an operation that the user interacts with the controlled device (such as a vehicular video and audio device, an air conditioner, and a TV) in a non-contact manner by use of the operating body and the screen. For example, the air operation may include, but not limited to, an operation performed based on a moving trajectory of the operating body, an operation performed based on a movement direction of the operating body, an operation performed based on a movement distance of the operating body, and an operation performed based on a posture (such as a gesture) of the operating body.

Generally speaking, the electronic device may obtain data to be recognized of the operating body acquired by a data acquisition device 104 shown in FIG. 1A, and recognize the data to be recognized, thereby determining the air operation of the operating body according to a recognition result. For example, the data acquisition device 104 may be a monocular camera, and the electronic device may recognize an image frame acquired in real time by the monocular camera to determine a position of the operating body in the image frame or a posture of the operating body. For another example, the data acquisition device 104 may be a binocular stereo camera, and the electronic device may recognize a binocular image acquired in real time by the binocular stereo camera to determine a position of the operating body in a three-dimensional space.

In step 203, a movement physical quantity of the icon on the screen is detected in response to the air operation.

In the present embodiment, the electronic device may detect a movement physical quantity of the icon on the screen in response to the air operation. The movement physical quantity may be a physical quantity of a specific feature of movement of the icon on the screen, such as a movement distance, movement speed, or movement direction of the icon.

In step 204, based on the movement physical quantity and a target function region in the graphic menu corresponding to the icon, a menu function corresponding to the target function region is triggered.

In the present embodiment, the electronic device, based on the movement physical quantity and a target function region in the graphic menu corresponding to the icon, may trigger a menu function corresponding to the target function region. The graphic menu may include at least one function region. Each function region may correspond to a menu function. The menu function may be preset. For example, the menu function may be popping up a sub-menu in the triggered function region, or controlling the controlled device to execute a corresponding function (such as playing a video, adjusting the volume, adjusting a temperature of the air conditioner, or controlling a window of the vehicle to be opened or closed). The menu function may be triggered in multiple manners. For example, the menu function is triggered when the icon moves to the target function region, or the menu function is triggered when the icon stays in the target function region for preset time. As shown in FIG. 1B, a sub-menu 10113 of a music function is popped up when the icon 10112 stays in a target function region marked as music for preset time.

The target function region may be a function region in correspondence with the icon in the at least one function region. For example, when the icon moves to a certain function region, it is determined that the icon is in correspondence with the function region, and then the function region is the target function region. In such case, if it is determined based on the movement physical quantity that the icon moves to a certain function region, the function region is the target function region. For another example, when a moving trajectory of the icon is consistent with a preset moving trajectory corresponding to a certain function region, it is determined that the icon is in correspondence with the function region, and then the function region is the target function region. In such case, if it is determined based on the movement physical quantity that the moving trajectory of the icon is consistent with a preset moving trajectory corresponding to a certain function region, the function region is the target function region.

According to the method provided in the above-mentioned embodiment of the present disclosure, the graphic menu and the icon in mapping with the operating body are displayed on the screen, then the air operation of the operating body with respect to the screen in the space is detected, meanwhile, the movement physical quantity of the icon on the screen is detected, and finally, the menu function corresponding to the target function region is triggered based on the movement physical quantity and the target function region in the graphic menu corresponding to the icon. As such, when a user performs air operations, the user may be guided visually by the graphic menu and icon displayed on the screen to perform the air operations with the operating body, and thus knows clearly how to trigger various functions with the operating body, which helps the user to perform air operations accurately. In addition, the number of menu items displayed on the graphic menu may be adjusted to further increase the number of menu functions triggered by air operations, so that the user may perform air operations more conveniently.

In some optional implementation modes, the method may further include the following step.

A menu pop-up operation of the operating body with respect to the screen is detected, and step 201 is performed in response to detecting the menu pop-up operation. Alternatively, a voice of a user is detected, and step 201 is performed in response to detecting that the voice includes a preset wakeup word (such as “pop up the menu”, “hello”, or other keywords).

The menu pop-up operation is an operation that the operating body moves in a specific manner, presents a special posture, etc., to trigger the graphic menu to be popped up. The method of detecting the voice of the user may be an existing voice recognition method. For example, a voice signal of the user may be converted into a text by use of a voice recognition model implemented based on a neural network, and then the preset wakeup word is determined from the text.

According to the present implementation mode, the menu pop-up operation of the operating body or the voice of the user is detected, so that the graphic menu may be popped up in diversified manners. Therefore, the flexibility of performing air operations by the user is improved, and air operations may be performed more conveniently.

In some optional implementation modes, as shown in FIG. 3, the electronic device may perform the following steps to detect the menu pop-up operation.

In step 301, a preset action of the operating body with respect to the screen is detected.

The preset action may be a static action (such as holding a posture at a certain position), or a dynamic action (such as moving according to a certain trajectory or changing the posture). The electronic device may detect the action of the operating body based on an existing action detection method (such as a deep-learning-based action detection method).

In step 302, a duration of the preset action is determined.

For example, when the operating body is a hand, gesture recognition may be performed on the hand, and if the gesture is a preset gesture, a duration of the gesture is determined. For another example, whether a moving trajectory of the operating body is a preset trajectory may be determined, and if YES, a duration of the moving trajectory is determined.

In step 303, it is determined that the menu pop-up operation of the operating body with respect to the screen is detected in case that the duration is more than or equal to preset time.

For example, assuming that the preset gesture is a V-shaped gesture, if the hand of the user holds the V-shaped gesture for more than or equal to first preset time, it is determined that the menu pop-up operation is performed, and then the graphic menu is popped up on the screen.

According to the present implementation mode, whether the operating body performs the menu pop-up operation is determined by detecting the duration of the preset action of the operating body, so that the complexity of the menu pop-up operation may be improved, and the probability of misoperation of the user may be reduced.

In some optional implementation modes, the operating body is a hand of the user. Based on this, the electronic device may detect the menu pop-up operation of the operating body by the following steps.

First, gesture recognition is performed on the hand of the user to obtain a gesture recognition result. A method for performing gesture recognition on the user may be implemented by a conventional art, and will not be elaborated herein.

Then, it is determined that the hand of the user performs the menu pop-up operation on the screen in case that a gesture indicated by the gesture recognition result is a preset gesture and the hand of the user is within a preset spatial range.

The preset spatial range may be a detection range of the data acquisition device 104 shown in FIG. 1A, or a preset range within a three-dimensional space corresponding to a display range of the screen. The preset gesture may be a static gesture (such as a V-shaped gesture or a first gesture), or a dynamic gesture (such as moving with a certain gesture according to a certain trajectory, or switching a plurality of preset gestures).

According to the present implementation mode, whether the operating body performs the menu pop-up operation is detected by gesture recognition, which is simpler in implementation mode and user operation mode, and contributes to popping up the graphic menu rapidly.

In some optional implementation modes, the electronic device may detect the menu pop-up operation of the operating body by the following steps.

First, a first moving trajectory of the operating body in the space is determined. A method for determining the moving trajectory of the operating body may be implemented based on a conventional art. For example, the data acquisition device 104 shown in FIG. 1A may be a camera, and the electronic device may perform trajectory recognition by use of multiple image frames of the operating body shot by the camera, thereby determining a first moving trajectory of the operating body.

Then, it is determined that the operating body performs the menu pop-up operation on the screen in case that the first moving trajectory is a first preset trajectory and the first moving trajectory is within a preset spatial range. For example, the first preset trajectory may be a round or wavy trajectory in the space.

According to the present implementation mode, the moving trajectory of the operating body is recognized, and the graphic menu is popped up when the moving trajectory is the first preset trajectory. It is only necessary to perform trajectory recognition rather than posture recognition on the operating body, which is easy to implement and high in recognition accuracy, and contributes to recognizing the menu pop-up operation efficiently.

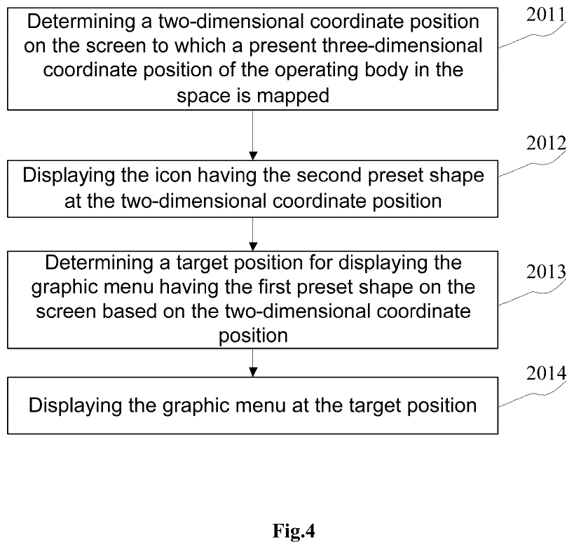

In some optional implementation modes, as shown in FIG. 4, step 201 may include the following sub-steps.

In step 2011, a two-dimensional coordinate position that a present three-dimensional coordinate position of the operating body in the space is mapped to on the screen is determined.

The electronic device may determine a three-dimensional coordinate position of the operating body by use of an existing spatial position detection method (for example, the three-dimensional coordinate position is determined by a depth image recognition method or a laser point cloud recognition method), and then determine a two-dimensional coordinate position that the operating body is presently mapped to on the screen based on a preset correspondence between a three-dimensional coordinate position and a two-dimensional coordinate position on the screen.

In step 2012, the icon of the second preset shape is displayed at the two-dimensional coordinate position.

In step 2013, a target position for displaying the graphic menu of the first preset shape on the screen is determined based on the two-dimensional coordinate position.

Generally speaking, the electronic device may determine a target position for displaying the graphic menu by taking the two-dimensional coordinate position as a reference position based on a preset correspondence between a position of the graphic menu and a reference position. For example, the reference position may be the target position, or a fixed position corresponding to a pre-divided grid region where the reference position is located is the target position.

In step 2014, the graphic menu is displayed at the target position.

For example, when the first preset shape is a round, the target position may be taken as the center of the round, thereby displaying the round graphic menu on the screen.

According to the present implementation mode, the two-dimensional coordinate position of the icon is determined first, and then the position of the graphic menu is determined based on the two-dimensional coordinate position of the icon, thereby associating the position of the graphic menu with a real-time spatial position of the operating body. Therefore, the user may control the display position of the graphic menu, convenience is brought to operations of the user, and the flexibility of the air operation is improved.

In some optional implementation modes, as shown in FIG. 5, step 201 may include the following sub-steps.

In step 2015, a preset initial position that the operating body is mapped to on the screen is determined.

The preset initial position may be a fixed position, such as a center of the screen. Alternatively, the preset initial position may be a position that the position of the operating body is mapped to for the first time on the screen when the method for guiding an operating body for air operation is started to be executed.

In step 2016, the icon of the second preset shape is displayed at the preset initial position.

In step 2017, a menu display position is determined based on the preset initial position.

Generally speaking, the electronic device may determine a menu display position for displaying the graphic menu by taking the preset initial position as a reference position based on a preset correspondence between a position of the graphic menu and a reference position. That is, the correspondence between the position of the graphic menu and the reference position may be preset, and the electronic device determines the menu display position for displaying the graphic menu according to the correspondence. For example, the reference position may be the menu display position, or a fixed position corresponding to a pre-divided grid region where the reference position is located is the menu display position.

In step 2018, the graphic menu of the first preset shape is displayed at the menu display position.

It is to be noted that steps 2015 to 2018 may be combined with the menu pop-up operation described in the above-mentioned optional embodiment. That is, steps 2015 to 2018 are performed when the menu pop-up operation is detected. For example, when it is detected that a gesture of the user is a preset gesture, the icon is displayed in the center of the screen (i.e., the preset initial position), and the round graphic menu is displayed by taking the center of the screen as the circle center.

According to the present implementation mode, the menu display position is determined based on the preset initial position, so that manners for popping up the graphic menu are enriched, meanwhile, the graphic menu may be displayed at a fixed position on the screen, the display position of the graphic menu does not change with the movement of the operating body, and the user needs not to look for the graphic menu on the screen. Therefore, the user may perform air operations more conveniently.

In some optional implementation modes, step 203 may be implemented by the following sub-steps.

First, a two-dimensional coordinate that a present three-dimensional coordinate of the operating body in the space is mapped to on the screen is determined.

Specifically, the electronic device may determine a two-dimensional coordinate that the operating body is presently mapped to on the screen in real time according to a preset mapping relationship between a space where the operating body is located and a display range of the screen.

Then, a variation of the two-dimensional coordinate on the screen is determined based on a variation of the three-dimensional coordinate during the air operation.

Generally speaking, a variation of the two-dimensional coordinate on the screen may be determined, without considering one coordinate axis (such as a coordinate axis parallel to an optical axis of the camera) of a three-dimensional coordinate system of the space where the operating body is located, according to coordinate variations of the other two coordinate axes and the mapping relationship.

Finally, the movement physical quantity of the icon on the screen is determined based on the variation of the two-dimensional coordinate.

A physical quantity of a movement direction (the movement direction may be represented by an included angle between a straight moving trajectory and a horizontal line), movement speed, moving trajectory, or the like of the icon may be determined as the movement physical quantity according to the variation of the two-dimensional coordinate.

According to the present implementation mode, the variation of the two-dimensional coordinate for mapping to the screen is determined based on the variation of the three-dimensional coordinate of the operating body to determine the movement physical quantity, so that the position of the operating body may be tracked accurately, and furthermore, the target function region in the graphic menu may be determined accurately, which helps the user to perform the air operation more accurately.

In some optional implementation modes, in step 204, the electronic device may trigger the menu function corresponding to the target function region according to any one of the following three modes.

The first mode: the menu function corresponding to the target function region is triggered in case that the icon moves to the target function region in the graphic menu and the icon stays in the target function region for a duration more than or equal to second preset time.

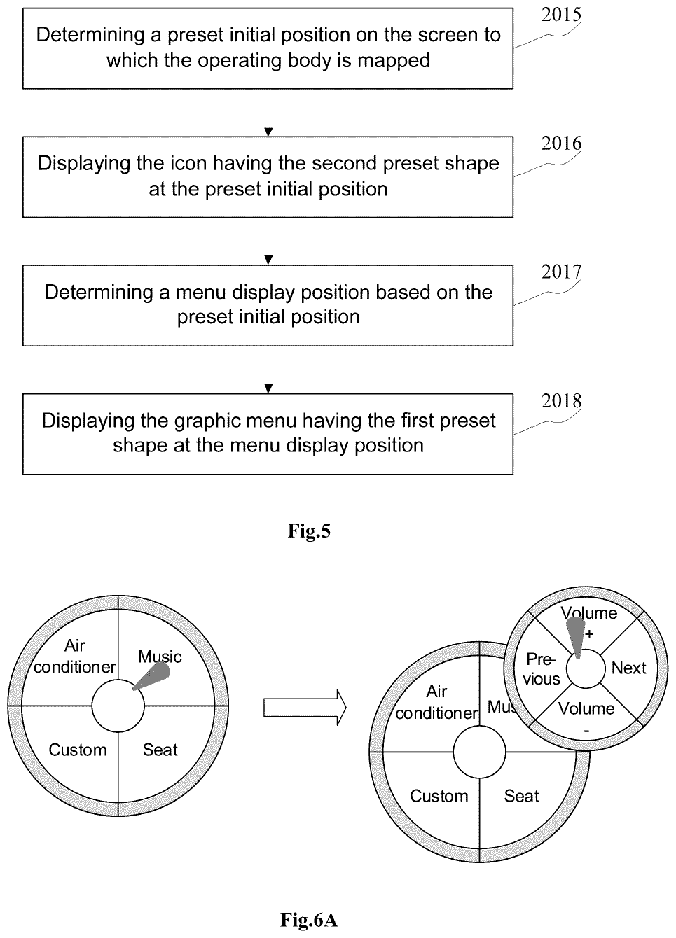

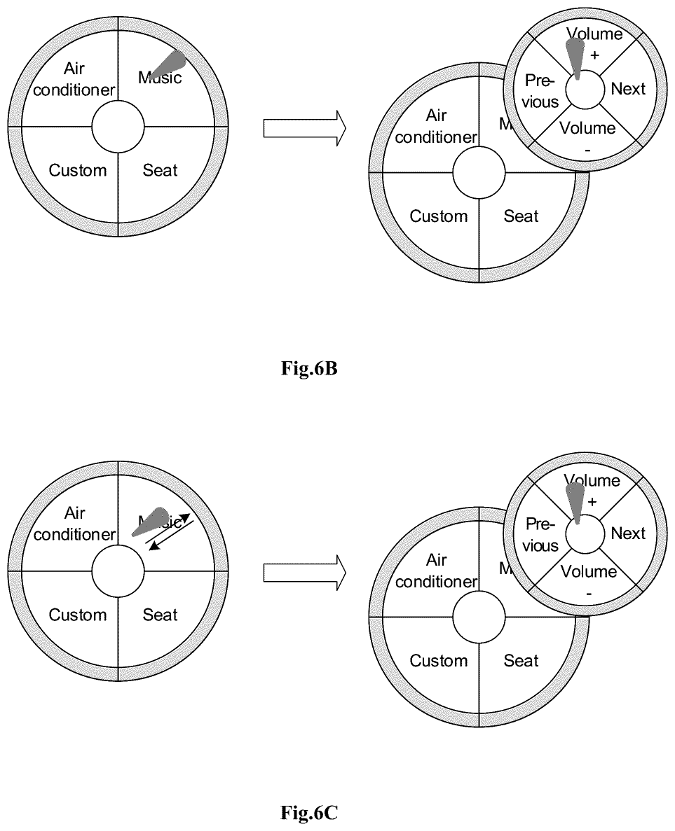

For example, as shown in FIG. 6A, the method for guiding an operating body for air operation is applied to a vehicle, the graphic menu displayed on a central control panel is a disc-shaped graphic menu, including four function regions marked as music, seat, custom, and air conditioner respectively, a central region of the graphic menu is an initial position of the above-mentioned icon, and the icon corresponding to the position of the operating body is a water drop-shaped icon. When the icon moves to the function region marked as music, the function region is the target function region, and meanwhile, timing is started. When the icon stays in the target function region for second preset time, a corresponding menu function is triggered, such as popping up sub-menus for adjusting the volume and changing the music in the figure.

The second mode: the menu function corresponding to the target function region is triggered in case that the icon is at a preset position in the target function region.

For example, as shown in FIG. 6B, when the icon contacts with a peripheral annular region of the disc-shaped graphic menu, a function region corresponding to the contacting annular region is determined as the target function region (i.e., the region marked as music in the figure), and sub-menus for adjusting the volume and changing the music in the figure are popped up.

The third mode: the menu function corresponding to the target function region is triggered in case that a second moving trajectory of the icon in the target function region is matched with a second preset trajectory.

For example, as shown in FIG. 6C, when a moving trajectory of the icon in the target function region (i.e., the region marked as music in the figure) is a reciprocating movement as shown by the arrow in the figure, sub-menus for adjusting the volume and changing the music in the figure are popped up.

According to the present implementation mode, multiple solutions for triggering the menu function corresponding to the target function region are provided, so that the flexibility of performing air operations by the user may be improved, and the user may select a triggering mode suitable for own habits conveniently.

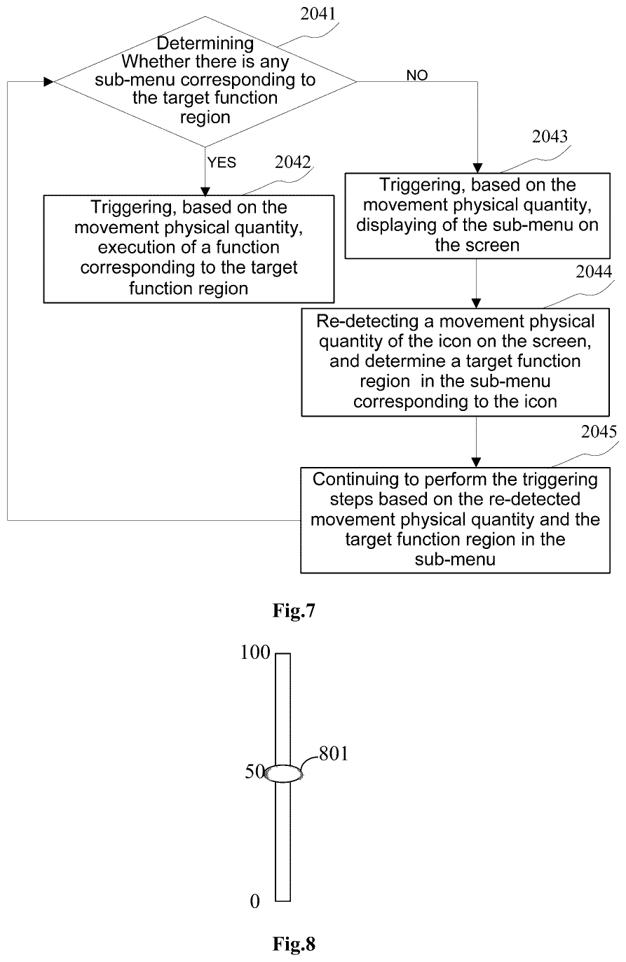

In some optional implementation modes, as shown in FIG. 7, step 204 may be implemented by the following sub-steps.

The following triggering steps (including steps 2041 to 2044) are performed based on the target function region.

In step 2041, whether there is any sub-menu corresponding to the target function region is determined.

Step 2042 is performed if there is no sub-menu. Step 2043 is performed if there is a sub-menu.

In step 2042, execution of a function corresponding to the target function region is triggered based on the movement physical quantity.

A method for triggering the function corresponding to the target function region may include, but not limited to, any one of the three modes in the above-mentioned implementation mode. For example, when the function corresponding to the target function region is enabling the navigation function, if the movement physical quantity satisfies a triggering condition, the navigation function is enabled.

In step 2043, displaying of the sub-menu is triggered on the screen based on the movement physical quantity, and step 2044 is performed.

A method for triggering displaying of the sub-menu may include, but not limited to, any one of the three modes in the above-mentioned implementation mode. As shown in FIG. 6A, 6B, or 6C, there is a sub-menu corresponding to the target function region marked as music. In such case, the sub-menu is popped up.

In step 2044, a movement physical quantity of the icon on the screen is re-detected, and a target function region in the sub-menu corresponding to the icon is determined.

A method for detecting the movement physical quantity is the same as step 203. A method for determining the target function region is the same as that for determining the target function region described in step 204. Elaborations are omitted herein.

In step 2045, the triggering steps continue to be performed based on the re-detected movement physical quantity and the target function region in the sub-menu.

When it is detected after multiple cycles that there is no more sub-menu in the present target function region, cycling is ended. According to the present implementation mode, the triggering steps are performed cyclically to implement air operations when the graphic menu is set to include multiple levels of sub-menus, so that functions realized by the air operations are enriched, which contributes to extending the graphic menu.

In some optional implementation modes, step 204 may further include the following sub-steps.

First, in case that a function corresponding to the target function region is a preset continuous adjustment function, an adjustment control interface corresponding to the continuous adjustment function is displayed on the screen.

As shown in FIG. 8, when the target function region is a function of continuously adjusting the volume, a bar-shaped adjustment control interface for adjusting the volume is displayed on the screen.

Then, based on a moving trajectory of a two-dimensional coordinate position that the operating body is presently mapped to on the screen, the continuous adjustment function is executed, and a control point on the adjustment control interface is controlled to move.

Specifically, a control point 801 shown in FIG. 8 may be moved up and down to adjust the volume according to the variation of the two-dimensional coordinate that the operating body is mapped to on the screen. For another example, the adjustment control interface may be shaped like a round knob, and when the moving trajectory of the operating body mapped to the screen is a round, the knob may be caused to rotate with the movement of the operating body to adjust the volume.

The present implementation mode provides an air operation method for continuously adjusting a specific function, so that a specific application may be adjusted accurately, air operation modes are enriched, and the accuracy of adjustment by air operations is improved.

In some optional implementation modes, in step 204, the electronic device may further highlight the target function region. Optionally, the target function region may be highlighted by high-brightness displaying, scaling up the target function region, or other manners. The target function region is highlighted, so that the user may know visually the position of the present target function region, which contributes to improving the accuracy of the air operation.

### Exemplary Apparatus

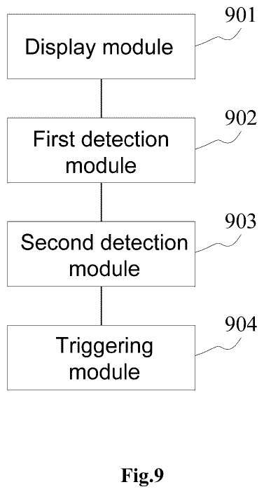

FIG. 9 is a schematic structure diagram of an apparatus for guiding an operating body for air operation according to an exemplary embodiment of the present disclosure. The present embodiment may be applied to an electronic device. As shown in FIG. 9, the apparatus for guiding an operating body for air operation includes a display module 901, a first detection module 902, a second detection module 903, and a triggering module 904. The display module 901 is configured to display, on a screen, a graphic menu having a first preset shape and an icon in mapping with an operating body and having a second preset shape. The first detection module 902 is configured to detect an air operation of the operating body with respect to the screen in a space. The second detection module 903 is configured to detect a movement physical quantity of the icon on the screen in response to the air operation. The triggering module 904 is configured to trigger, based on the movement physical quantity and a target function region in the graphic menu corresponding to the icon, a menu function corresponding to the target function region.

In the present embodiment, the display module 901 may display, on a screen, a graphic menu having a first preset shape and an icon in mapping with an operating body and having a second preset shape. The screen may be a screen of any type of electronic device, such as a central control panel in a vehicle, a smart TV placed indoors, or a smart phone.

The first preset shape of the graphic menu may be any shape. For example, the graphic menu may be a round menu or a rectangular menu. The graphic menu includes at least one function region. Each function region may be triggered to execute a corresponding menu function, such as popping up a sub-menu, performing volume adjustment, changing the music, or controlling a specific device to be turned on or off.

The operating body may be various hardware entities or a specific body part of a user performing air operations on a controlled device. For example, the operating body may be a body part of the user such as a hand or the head, or a hardware entity capable of outputting position information to the apparatus such as a handle, or another object of a specific shape.

The display module 901 may detect a position of the operating body in a space in real time, map the detected position to a corresponding position on the screen, and display an icon having a second preset shape at the corresponding position on the screen, thereby presenting an effect that a position of the icon moves with the operating body. The second preset shape may be various shapes, such as a sphere, a point, or a pointer.

In the present embodiment, the first detection module 902 may detect an air operation of the operating body with respect to the screen in a space in real time based on various methods. The air operation may be an operation that the user interacts with the controlled device (such as a vehicular video and audio device, an air conditioner, and a TV) in a non-contact manner by use of the operating body and the screen. For example, the air operation may include, but not limited to, an operation performed based on a moving trajectory of the operating body, an operation performed based on a movement direction of the operating body, an operation performed based on a movement distance of the operating body, and an operation performed based on a posture (such as a gesture) of the operating body.

Generally speaking, the first detection module 902 may obtain data to be recognized of the operating body acquired by a data acquisition device 104 shown in FIG. 1A, and recognize the data to be recognized, thereby detecting the air operation of the operating body. For example, the data acquisition device 104 may be a monocular camera, and the first detection module 902 may recognize an image frame acquired in real time by the monocular camera to determine a position of the operating body in the image frame or a posture of the operating body. For another example, the data acquisition device 104 may be a binocular stereo camera, and the first detection module 902 may recognize a binocular image acquired in real time by the binocular stereo camera to determine a position of the operating body in a three-dimensional space.

In the present embodiment, the second detection module 903 may detect a movement physical quantity of the icon on the screen in response to the air operation. The movement physical quantity may be a physical quantity of a specific feature of movement of the icon on the screen, such as a movement distance, movement speed, or movement direction of the icon.

In the present embodiment, the triggering module 904, based on the movement physical quantity and a target function region in the graphic menu corresponding to the icon, may trigger a menu function corresponding to the target function region. The graphic menu may include at least one function region. Each function region may correspond to a menu function. The menu function may be preset. For example, the menu function may be popping up a sub-menu in the triggered function region, or controlling the controlled device to execute a corresponding function (such as playing a video, adjusting the volume, adjusting a temperature of the air conditioner, or controlling a window of the vehicle to be opened or closed). The menu function may be triggered in multiple manners. For example, the menu function is triggered when the icon moves to the target function region, or the menu function is triggered when the icon stays in the target function region for preset time.

The target function region may be a function region in correspondence with the icon in the at least one function region. For example, when the icon moves to a certain function region, it is determined that the icon is in correspondence with the function region, and then the function region is the target function region. For another example, when a moving trajectory of the icon is consistent with a preset moving trajectory corresponding to a certain function region, it is determined that the icon is in correspondence with the function region, and then the function region is the target function region.

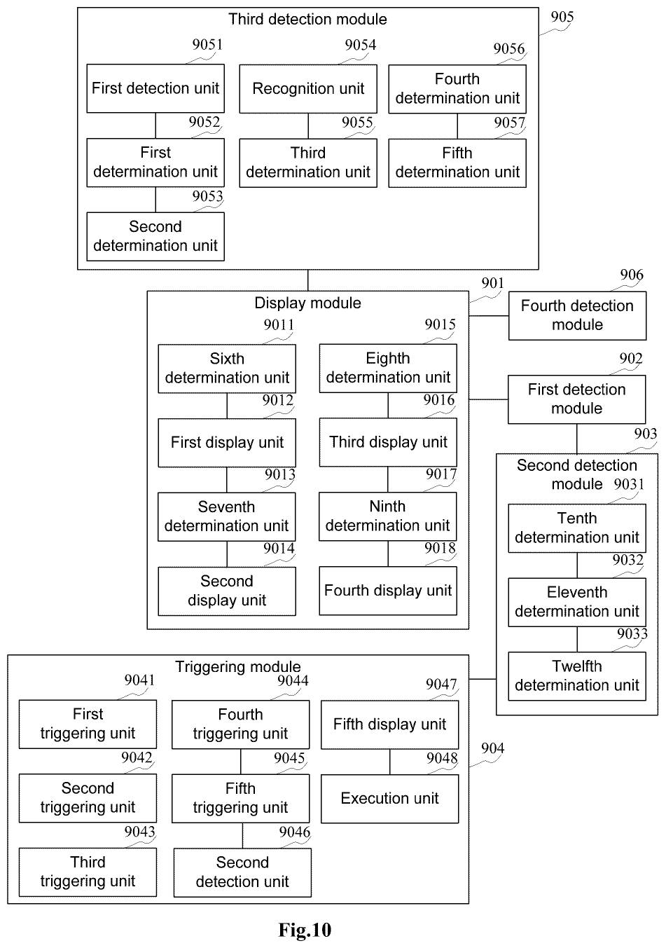

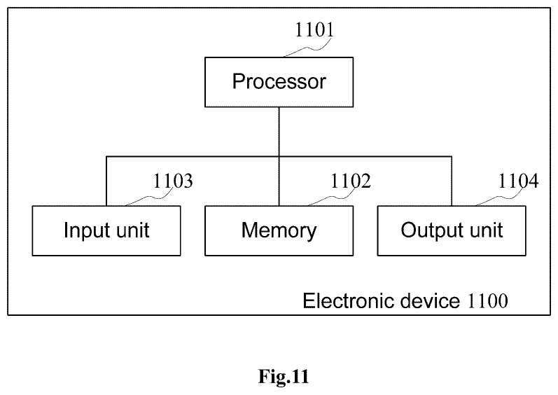

Referring to FIG. 10, FIG. 10 is a schematic structure diagram of an apparatus for guiding an operating body for air operation according to another exemplary embodiment of the present disclosure.

In some optional implementation modes, the apparatus further includes a third detection module 905 or a fourth detection module 906. The third detection module 905 is configured to detect a menu pop-up operation of the operating body with respect to the screen, and execute, in response to detecting the menu pop-up operation, the step of displaying, on a screen, a graphic menu having a first preset shape and an icon in mapping with an operating body and having a second preset shape. The fourth detection module 906 is configured to detect a voice of a user, and execute, in response to detecting that the voice comprises a preset wakeup word, the step of displaying, on a screen, a graphic menu having a first preset shape and an icon in mapping with an operating body and having a second preset shape.

In some optional implementation modes, the third detection module 905 includes a first detection unit 9051, a first determination unit 9052, and a second determination unit 9053. The first detection unit 9051 is configured to detect a preset action of the operating body with respect to the screen. The first determination unit 9052 is configured to determine a duration of the preset action. The second determination unit 9053 is configured to determine that the menu pop-up operation of the operating body with respect to the screen is detected in case that the duration is more than or equal to preset time.

In some optional implementation modes, the operating body is a hand of the user. The third detection module 905 includes a recognition unit 9054 and a third determination unit 9055. The recognition unit 9054 is configured to perform gesture recognition on the hand of the user to obtain a gesture recognition result. The third determination unit 9055 is configured to determine that the hand of the user performs the menu pop-up operation on the screen in case that a gesture indicated by the gesture recognition result is a preset gesture and the hand of the user is within a preset spatial range.

In some optional implementation modes, the third detection module 905 includes a fourth determination unit 9056 and a fifth determination unit 9057. The fourth determination unit 9056 is configured to determine a first moving trajectory of the operating body in the space. The fifth determination unit 9057 is configured to determine that the operating body performs the menu pop-up operation on the screen in case that the first moving trajectory is a first preset trajectory and the first moving trajectory is within a preset spatial range.

In some optional implementation modes, the display module 901 includes a sixth determination unit 9011, a first display unit 9012, a seventh determination unit 9013, and a second display unit 9014. The sixth determination unit 9011 is configured to determine a two-dimensional coordinate position that a present three-dimensional coordinate position of the operating body in the space is mapped to on the screen. The first display unit 9012 is configured to display the icon of the second preset shape at the two-dimensional coordinate position. The seventh determination unit 9013 is configured to determine a target position for displaying the graphic menu of the first preset shape on the screen based on the two-dimensional coordinate position. The second display unit 9014 is configured to display the graphic menu at the target position.

In some optional implementation modes, the display module 901 includes an eighth determination unit 9015, a third display unit 9016, a ninth determination unit 9017, and a fourth display unit 9018. The eighth determination unit 9015 is configured to determine a preset initial position that the operating body is mapped to on the screen. The third display unit 9016 is configured to display the icon of the second preset shape at the preset initial position. The ninth determination unit 9017 is configured to determine a menu display position based on the preset initial position. The fourth display unit 9018 is configured to display the graphic menu of the first preset shape at the menu display position.

In some optional implementation modes, the second detection module 903 includes a tenth determination unit 9031, an eleventh determination unit 9032, and a twelfth determination unit 9033. The tenth determination unit 9031 is configured to determine a two-dimensional coordinate that a present three-dimensional coordinate of the operating body in the space is mapped to on the screen. The eleventh determination unit 9032 is configured to determine a variation of the two-dimensional coordinate on the screen based on a variation of the three-dimensional coordinate during the air operation. The twelfth determination unit 9033 is configured to determine the movement physical quantity of the icon on the screen based on the variation of the two-dimensional coordinate.

In some optional implementation modes, the triggering module 904 includes a first triggering unit 9041, or a second triggering unit 9042, or a third triggering unit 9043. The first triggering unit 9041 is configured to trigger the menu function corresponding to the target function region in case that the icon moves to the target function region in the graphic menu and the icon stays in the target function region for a duration more than or equal to second preset time. The second triggering unit 9042 is configured to trigger the menu function corresponding to the target function region in case that the icon is at a preset position in the target function region. The third triggering unit 9043 is configured to trigger the menu function corresponding to the target function region in case that a second moving trajectory of the icon in the target function region is matched with a second preset trajectory.

In some optional implementation modes, the triggering module 904 includes a fourth triggering unit 9044, a fifth triggering unit 9045, and a second detection unit 9046. The fourth triggering unit 9044 is configured to perform, based on the target function region, the following triggering steps: determining whether there is any sub-menu corresponding to the target function region, and triggering, based on the movement physical quantity in case that there is no sub-menu, execution of a function corresponding to the target function region. The fifth triggering unit 9045 is configured to trigger, based on the movement physical quantity in case that there is a sub-menu, displaying of the sub-menu on the screen. The second detection unit 9046 is configured to re-detect a movement physical quantity of the icon on the screen, determine a target function region in the sub-menu corresponding to the icon, and continue to perform the triggering steps based on the re-detected movement physical quantity and the target function region in the sub-menu.

In some optional implementation modes, the triggering module 904 includes a fifth display unit 9047 and an execution unit 9048. The fifth display unit 9047 is configured to display, in case that a function corresponding to the target function region is a preset continuous adjustment function, an adjustment control interface corresponding to the continuous adjustment function on the screen. The execution unit 9048 is configured to, based on a moving trajectory of a two-dimensional coordinate position that the operating body is presently mapped to on the screen, execute the continuous adjustment function and control a control point on the adjustment control interface to move.

In some optional implementation modes, the triggering module is further configured to highlight the target function region.

According to the apparatus for guiding an operating body for air operation in the above-mentioned embodiment of the present disclosure, the graphic menu and the icon in mapping with the operating body are displayed on the screen, then the air operation of the operating body with respect to the screen in the space is detected, meanwhile, the movement physical quantity of the icon on the screen is detected, and finally, the menu function corresponding to the target function region is triggered based on the movement physical quantity and the target function region in the graphic menu corresponding to the icon. As such, when a user performs air operations, the user may be guided visually by the graphic menu and icon displayed on the screen to perform the air operations with the operating body, and thus knows clearly how to trigger various functions with the operating body, which helps the user to perform air operations accurately. In addition, the number of functions triggered by air operations may be increased under the assistance of the graphic menu, thereby further making it more convenient for the user to perform air operations.

### Exemplary Electronic Device

An electronic device according to the embodiments of the present disclosure will now be described with reference to FIG. 11. The electronic device may be any one or two of the terminal device 101 and server 103 shown in FIG. 1A, or a standalone device independent of them. The standalone device may communicate with the terminal device 101 and the server 103, so as to receive acquired input signals therefrom.

FIG. 11 is a block diagram of an electronic device according to an embodiment of the present disclosure.

As shown in FIG. 11, the electronic device 1100 includes one or more processors 1101 and a memory 1102.

The processor 1101 may be a Central Processing Unit (CPU) or a processing unit of another form with a data processing capability and/or an instruction execution capability, and may control other components of the electronic device 1101 to execute desired functions.

The memory 1102 may include one or more computer program products that may include various forms of computer-readable storage media, such as a volatile memory and/or a non-volatile memory. The volatile memory may include, for example, a Random Access Memory (RAM) and/or a cache. The nonvolatile memory may include, for example, a Read-Only Memory (ROM), a hard disk, and a flash memory. One or more computer program instructions may be stored in the computer-readable storage medium. The processor 1101 may run the program instructions so as to implement the above method for guiding an operating body for air operation in each embodiment of the present disclosure and/or other desired functions. Various contents such as images and control instructions may also be stored in the computer-readable storage medium.

In an example, the electronic device 1100 may further include an input unit 1103 and an output unit 1104. These components are interconnected by a bus system and/or another form of connecting mechanism (not shown).

For example, when the electronic device is the terminal device 101 or the server 103, the input unit 1103 may be a camera, a laser radar, a mouse, a keyboard, a microphone, or other devices, and is configured to input information such as images and instructions. When the electronic device is a standalone device, the input unit 1103 may be a communication network connector, and is configured to receive information such as input images and instructions from the terminal device 101 and the server 103.

The output unit 1104 may externally output all kinds of information, including a graphic menu and other information. The output unit 1104 may include, for example, a display, a loudspeaker, a printer, and a communication network as well as a remote output device connected thereto.

Certainly, for simplicity, FIG. 11 only shows some of components related to the present disclosure in the electronic device 1100, and omits components such as a bus and an input/output interface. In addition, the electronic device 1100 may further include any other proper components according to a specific application situation.

### Exemplary Computer Program Product and Computer-Readable Storage Medium

In addition to the above-mentioned method and device, the embodiments of the present disclosure may also provide a computer program product including computer program instructions which, when being run by a processor, cause the processor to perform the steps in the method for guiding an operating body for air operation according to each embodiment of the present disclosure in “exemplary method” of the specification.

A program code for executing the operation in the embodiment of the present disclosure in the computer program product may be edited by use of any combination of one or more program design languages. The program design languages include object-oriented program design languages such as Java and C++, and further include conventional procedural program design languages such as “C” language or a similar program design language. The program code may be completely executed in a computing device of a user, partially executed in user equipment, executed as an independent software package, executed partially in the computing device of the user and partially in a remote computing device, or executed completely in the remote computing device or a server.

In addition, the embodiments of the present disclosure may also provide a computer-readable storage medium storing computer program instructions which, when being run by a processor, cause the processor to perform the steps in the method for guiding an operating body for air operation according to each embodiment of the present disclosure in “exemplary method” of the specification.

The computer-readable storage medium may use any combination of one or more readable media. The readable medium may be a readable signal medium or a readable storage medium. The readable storage medium may include, but not limited to, for example, an electrical, magnetic, optical, electromagnetic, infrared, or semiconductor system, apparatus, or device, or any combination thereof. More specific examples (non-exhaustive list) of the readable storage medium include an electrical connection with one or more wires, a portable disk, a hard disk, a RAM, a ROM, an Erasable Programmable ROM (EPROM) (or a flash memory), an optical fiber, a portable Compact Disc ROM (CD-ROM), an optical memory device, a magnetic memory device, or any proper combination thereof.

The basic principle of the present disclosure is described above in combination with specific embodiments. However, it is to be pointed out that the advantages, superiorities, effects, etc., mentioned in the present disclosure are only exemplary rather than restrictive, and these advantages, superiorities, effects, etc., may be regarded as optional for each embodiment of the present disclosure. In addition, the specific details disclosed above are only for illustration and ease of understanding rather than restrictive, and the details do not limit the implementation of the present disclosure.

Each embodiment in the specification is described progressively. Descriptions made in each embodiment focus on differences with the other embodiments, and the same or similar parts in each embodiment refer to the other embodiments. The system embodiment substantially corresponds to the method embodiment and thus is described relatively simply, and related parts refer to part of the descriptions about the method embodiment.

The block diagrams of the device, apparatus, equipment, and system involved in the present disclosure are only examples and not intended to require or imply connection, arrangement, and configuration to be performed necessarily in manners shown in the block diagrams. As realized by those skilled in the art, the device, apparatus, equipment, and system may be connected, arranged, and configured in any manner. Terms such as “include”, “contain”, and “have” are open terms, and refer to and are interchangeable with “include, but not limited to”. Terms “or” and “and” used herein refer to and are interchangeable with “and/or”, unless otherwise indicated explicitly in the context. Term “such as” used herein refers to and is interchangeable with “such as, but not limited to”.

The method and apparatus of the present disclosure may be implemented in various manners. For example, the method and apparatus of the present disclosure may be implemented by software, hardware, firmware, or any combination of software, hardware, and firmware. The sequence for the steps of the method is only for description, and the steps of the method of the present disclosure are not limited to the sequence specifically described above, unless otherwise specified in another manner. In addition, in some embodiments, the present disclosure may also be implemented as a program recorded in a recording medium, and the program includes machine-readable instructions for implementing the method according to the present disclosure. Therefore, the present disclosure also covers the recording medium storing the program for executing the method according to the present disclosure.

It is also to be pointed out that each component or each step in the apparatus, device, and method of the present disclosure may be split and/or recombined. The splitting and/or recombination should be considered as equivalent solutions of the present disclosure.

The above descriptions about the disclosed aspects are provided such that those skilled in the art may implement or use the present disclosure. Various modifications about these aspects are apparent to those skilled in the art, and general principles defined herein may be applied to other aspects without departing from the scope of the present disclosure. Therefore, the present disclosure is not limited to the aspects shown herein but intended to cover the largest scope consistent with the principles and novel features disclosed herein.

The above descriptions have been provided for purposes of illustration and description. In addition, the descriptions are not intended to limit the embodiments of the present disclosure to the forms disclosed herein. Although multiple exemplary aspects and embodiments have been discussed above, those skilled in the art will learn some transformations, modifications, variations, additions, and sub-combinations thereof.

1. A method for guiding an operating body for air operation, comprising:
displaying, on a screen, a graphic menu having a first preset shape and an icon in mapping with an operating body and having a second preset shape;
detecting an air operation of the operating body with respect to the screen in a space;
detecting a movement physical quantity of the icon on the screen in response to the air operation; and
triggering, based on the movement physical quantity and a target function region in the graphic menu corresponding to the icon, a menu function corresponding to the target function region.

2. The method according to claim 1, further comprising:
detecting a menu pop-up operation of the operating body with respect to the screen, and executing, in response to detecting the menu pop-up operation, the step of displaying, on a screen, a graphic menu having a first preset shape and an icon in mapping with an operating body and having a second preset shape; or
detecting a voice of a user, and executing, in response to detecting that the voice comprises a preset wakeup word, the step of displaying, on a screen, a graphic menu having a first preset shape and an icon in mapping with an operating body and having a second preset shape.

3. The method according to claim 2, wherein the detecting a menu pop-up operation of the operating body with respect to the screen comprises:
detecting a preset action of the operating body with respect to the screen;
determining a duration of the preset action; and
determining that the menu pop-up operation of the operating body with respect to the screen is detected in case that the duration is more than or equal to preset time.

4. The method according to claim 2, wherein the operating body is a hand of the user; and
the detecting a menu pop-up operation of the operating body with respect to the screen comprises:
performing gesture recognition on the hand of the user to obtain a gesture recognition result; and
determining that the hand of the user performs the menu pop-up operation on the screen in case that a gesture indicated by the gesture recognition result is a preset gesture and the hand of the user is within a preset spatial range.

5. The method according to claim 2, wherein the detecting a menu pop-up operation of the operating body with respect to the screen comprises:
determining a first moving trajectory of the operating body in the space; and
determining that the operating body performs the menu pop-up operation on the screen in case that the first moving trajectory is a first preset trajectory and the first moving trajectory is within a preset spatial range.

6. The method according to claim 1, wherein the displaying, on a screen, a graphic menu having a first preset shape and an icon in mapping with an operating body and having a second preset shape comprises:
determining a two-dimensional coordinate position on the screen to which a present three-dimensional coordinate position of the operating body in the space is mapped;
displaying the icon of the second preset shape at the two-dimensional coordinate position;
determining a target position for displaying the graphic menu of the first preset shape on the screen based on the two-dimensional coordinate position; and
displaying the graphic menu at the target position.

7. The method according to claim 1, wherein the displaying, on a screen, a graphic menu having a first preset shape and an icon in mapping with an operating body and having a second preset shape comprises:
determining a preset initial position on the screen to which the operating body is mapped;
displaying the icon of the second preset shape at the preset initial position;
determining a menu display position based on the preset initial position; and
displaying the graphic menu of the first preset shape at the menu display position.

8. (canceled)

9. The method according to claim 1, wherein in triggering a menu function corresponding to the target function region comprises:
triggering the menu function corresponding to the target function region in case that the icon moves to the target function region in the graphic menu and the icon stays in the target function region for a duration more than or equal to second preset time; or
triggering the menu function corresponding to the target function region in case that the icon is at a preset position in the target function region; or
triggering the menu function corresponding to the target function region in case that a second moving trajectory of the icon in the target function region is matched with a second present trajectory; or
wherein the triggering a menu function corresponding to the target function region comprises:
displaying, in case that a function corresponding to the target function region is a preset continuous adjustment function, an adjustment control interface corresponding to the continuous adjustment function on the screen; and
based on a moving trajectory of a two-dimensional coordinate position on the screen to which the operating body is presently mapped, executing the continuous adjustment function, and controlling a control point on the adjustment control interface to move.

10.-12. (canceled)

13. A computer-readable storage medium, storing a computer program which is used for executing the method of claim 1.

14. An electronic device, comprising:
a processor; and
a memory, configured to store instructions executable for the processor;
wherein the processor is configured to read the executable instructions from the memory and execute the instructions to implement the method of claim 1.

15. The computer-readable storage medium according to claim 9, wherein the method further comprising:
detecting a menu pop-up operation of the operating body with respect to the screen, and executing, in response to detecting the menu pop-up operation, the step of displaying, on a screen, a graphic menu having a first preset shape and an icon in mapping with an operating body and having a second preset shape; or
detecting a voice of a user, and executing, in response to detecting that the voice comprises a preset wakeup word, the step of displaying, on a screen, a graphic menu having a first preset shape and an icon in mapping with an operating body and having a second preset shape.

16. The computer-readable storage medium according to claim 10, wherein the detecting a menu pop-up operation of the operating body with respect to the screen comprises:
detecting a preset action of the operating body with respect to the screen;
determining a duration of the preset action; and
determining that the menu pop-up operation of the operating body with respect to the screen is detected in case that the duration is more than or equal to preset time; or
wherein the detecting a menu pop-up operation of the operating body with respect to the screen comprises:
determining a first moving trajectory of the operating body in the space; and
determining that the operating body performs the menu pop-up operation on the screen in case that the first moving trajectory is a first preset trajectory and the first moving trajectory is within a preset spatial range.

17. The computer-readable storage medium according to claim 10, wherein the operating body is a hand of the user; and
the detecting a menu pop-up operation of the operating body with respect to the screen comprises:
performing gesture recognition on the hand of the user to obtain a gesture recognition result; and
determining that the hand of the user performs the menu pop-up operation on the screen in case that a gesture indicated by the gesture recognition result is a preset gesture and the hand of the user is within a preset spatial range.

18. The computer-readable storage medium according to claim 9, wherein the displaying, on a screen, a graphic menu having a first preset shape and an icon in mapping with an operating body and having a second preset shape comprises:
determining a two-dimensional coordinate position on the screen to which a present three-dimensional coordinate position of the operating body in the space is mapped;
displaying the icon of the second preset shape at the two-dimensional coordinate position;
determining a target position for displaying the graphic menu of the first preset shape on the screen based on the two-dimensional coordinate position; and
displaying the graphic menu at the target position; or
wherein the displaying, on a screen, a graphic menu having a first preset shape and an icon in mapping with an operating body and having a second preset shape comprises:
determining a preset initial position on the screen to which the operating body is mapped;
displaying the icon of the second preset shape at the preset initial position;
determining a menu display position based on the preset initial position; and
displaying the graphic menu of the first preset shape at the menu display position.

19. The computer-readable storage medium according to claim 9, wherein the triggering a menu function corresponding to the target function region comprises:
triggering the menu function corresponding to the target function region in case that the icon moves to the target function region in the graphic menu and the icon stays in the target function region for a duration more than or equal to second preset time; or
triggering the menu function corresponding to the target function region in case that the icon is at a preset position in the target function region; or
triggering the menu function corresponding to the target function region in case that a second moving trajectory of the icon in the target function region is matched with a second preset trajectory; or
wherein the triggering a menu function corresponding to the target function region comprises:
displaying, in case that a function corresponding to the target function region is a preset continuous adjustment function, an adjustment control interface corresponding to the continuous adjustment function on the screen; and
based on a moving trajectory of a two-dimensional coordinate position on the screen to which the operating body is presently mapped, executing the continuous adjustment function, and controlling a control point on the adjustment control interface to move.

20. The electronic device according to claim 15, wherein the method further comprising:
detecting a menu pop-up operation of the operating body with respect to the screen, and executing, in response to detecting the menu pop-up operation, the step of displaying, on a screen, a graphic menu having a first preset shape and an icon in mapping with an operating body and having a second preset shape; or
detecting a voice of a user, and executing, in response to detecting that the voice comprises a preset wakeup word, the step of displaying, on a screen, a graphic menu having a first preset shape and an icon in mapping with an operating body and having a second preset shape.

21. The electronic device according to claim 16, wherein the detecting a menu pop-up operation of the operating body with respect to the screen comprises:
detecting a preset action of the operating body with respect to the screen;
determining a duration of the preset action; and
determining that the menu pop-up operation of the operating body with respect to the screen is detected in case that the duration is more than or equal to preset time; or
wherein the detecting a menu pop-up operation of the operating body with respect to the screen comprises:
determining a first moving trajectory of the operating body in the space; and
determining that the operating body performs the menu pop-up operation on the screen in case that the first moving trajectory is a first preset trajectory and the first moving trajectory is within a preset spatial range.

22. The electronic device according to claim 16, wherein the operating body is a hand of the user; and
the detecting a menu pop-up operation of the operating body with respect to the screen comprises:
performing gesture recognition on the hand of the user to obtain a gesture recognition result; and
determining that the hand of the user performs the menu pop-up operation on the screen in case that a gesture indicated by the gesture recognition result is a preset gesture and the hand of the user is within a preset spatial range.

23. The electronic device according to claim 15, wherein the displaying, on a screen, a graphic menu having a first preset shape and an icon in mapping with an operating body and having a second preset shape comprises:
determining a two-dimensional coordinate position on the screen to which a present three-dimensional coordinate position of the operating body in the space is mapped;
displaying the icon of the second preset shape at the two-dimensional coordinate position;
determining a target position for displaying the graphic menu of the first preset shape on the screen based on the two-dimensional coordinate position; and
displaying the graphic menu at the target position; or
wherein the displaying, on a screen, a graphic menu having a first preset shape and an icon in mapping with an operating body and having a second preset shape comprises:
determining a preset initial position on the screen to which the operating body is mapped;
displaying the icon of the second preset shape at the preset initial position;
determining a menu display position based on the preset initial position; and
displaying the graphic menu of the first preset shape at the menu display position.

24. The electronic device according to claim 15, wherein the triggering a menu function corresponding to the target function region comprises:
triggering the menu function corresponding to the target function region in case that the icon moves to the target function region in the graphic menu and the icon stays in the target function region for a duration more than or equal to second preset time; or
triggering the menu function corresponding to the target function region in case that the icon is at a preset position in the target function region; or
triggering the menu function corresponding to the target function region in case that a second moving trajectory of the icon in the target function region is matched with a second preset trajectory; or
wherein the triggering a menu function corresponding to the target function region comprises:
displaying, in case that a function corresponding to the target function region is a preset continuous adjustment function, an adjustment control interface corresponding to the continuous adjustment function on the screen; and
based on a moving trajectory of a two-dimensional coordinate position on the screen to which the operating body is presently mapped, executing the continuous adjustment function, and controlling a control point on the adjustment control interface to move.
